(19) United States
(12) Patent Application Publication
(10) Pub. No.: US 2015/0300567 A1
(43) Pub. Date: Oct. 22, 2015

(54) MECHANISM FOR RELEASEABLY ARRESTING A PREDETERMINABLE STATE OF A DEVICE, AND SAFETY SWITCH HAVING SUCH A MECHANISM

(71) Applicant: EUCHNER GMBH + CO. KG, Leinfelden-Echterdingen (DE)

(72) Inventor: Ilo Grimm, Waldenbuch (DE)

(21) Appl. No.: 14/437,579

(22) PCT Filed: Oct. 17, 2013
(86) PCT No.: PCT/EP2013/003121

§ 371 Date: Apr. 22, 2015

(30) Foreign Application Priority Data
Oct. 31, 2012 (DE) 10 2012 021 968.7

(51) Int. Cl. F16P 3/08; H01H 9/28

(52) U.S. Cl. CPC F16P 3/08; H01H 9/286

(57) ABSTRACT

Mechanism (10) for releaseably arresting a predeterminable state of a device (1), in particular for releasably maintaining the closed state of a safety device of a machine (2), having an engagement device (20), which can be secured on a first part (4) of the device (1) and has at least one engagement element (22) which, in the predeterminable state of the device (1) which is to be arrested, can be brought into engagement with an accommodating device (30), which can be secured on a second part (8) of the device (1) or is a constituent part of the second part (8) of the device (1), and the predeterminable state, of the device (1) can be arrested as a result, characterized in that the engagement element (22) can be rotated out of a starting position about a first axis (24) and, in the predeterminable state of the device (1) which is to be arrested, can be brought into engagement with the accommodating device (30), and in that the mechanism (10) has an arresting element (26) which can be activated in a controlled manner and which, upon activation, can be brought into abutment against the engagement element (22) and therefore provides a form fit to block the engagement element (22) against rotating back, and thus arrests the predeterminable state of the device (1), and a safety switch (40) having such a mechanism (10).

The present invention relates to an apparatus for releasably locking a device in a predefinable state, in particular for releasably locking or keeping the safety device of a machine or the like in the closed state, as well as a safety switch having such an apparatus.

Safety switches are used, for example, to monitor the state of a safety device of a machine, for example for monitoring the closed state of a guard door of a protected area for a machine tool or industrial robot. When the safety device is in a closed state, the safety switch can provide a signal to enable the operation of the machine. When the safety device is opened, the safety switch interrupts one or a plurality of circuits, for example by means of an electrical contact pair, which is actuated by means of an interlocking effect, or by means of an electronic switching element.

In addition, the enable signal is no longer provided. Thereupon, the corresponding machine can be switched into a safe operating state, for example by being switched off, or the turning on of the machine may be prevented.

In some applications, it must be possible to releasably lock the safety device in a closed state, for example when it is necessary to prevent the safety device from being opened when the machine is in an operating state. The lock is only released and the safety device can only be opened when the machine is at a complete standstill.

In the case of safety switches having mechanical actuators, such locking or guard control is implemented by locking the mechanical actuator in a state, in which said actuator is inserted in a switch head of the safety switch, as is known from DE 43 28 297 C1 or DE 10 2004 038 488 A1. A contactless position switch is known from DE 197 11 588 A1 or DE 10 2004 049 024 B3. A guard control for a safety switch having an electronic actuator, which guard control uses magnetic force, is known from DE 101 46 828 A1.

In practice, the configuration of such apparatuses and safety switches must be adapted to the specific structural circumstances, for example, depending on where the safety device of the machine provides sufficient installation space, in which the apparatus or the safety switch can be disposed.

The object of the present invention is to provide an apparatus conforming to its genre or, respectively, an associated safety switch, which, on the one hand, requires as little installation space as possible, but on the other hand, meets the highest safety requirements, including in terms of locking force. In one embodiment, it should be possible to dispose the apparatus or, respectively, the safety switch in such a way that the

operator is protected from injury and the apparatus or, respectively, the safety switch is protected against mechanical damage.

In one embodiment of the invention, the problem is solved by the apparatus specified in Claim 1 and by the safety switch specified in the independent coordinate Claim. Further embodiments are specified in the dependent Claims and the following description.

In one embodiment, the invention relates to an apparatus for releasably locking a device in a predefinable state, in particular for releasably keeping a safety device of a machine in the closed state, said apparatus having an engagement device, which can be secured on a first, preferably fixed part of the device, and having at least one engagement element, which can be brought into engagement with a receiving device when the device is in the predefinable state, in which said device is to be locked, which receiving device can be secured on a second part of the device, which preferably can be moved relative to the first part, or is an integral component of the second part of the device, as a result of which, the device can be locked in the predefinable state. The engagement element can be rotated about a first axis, out of a starting position, and in so doing, can be brought into engagement with the receiving device when the device is in the predefinable state, in which it is to be locked. The apparatus has a locking element, which can be activated in a controlled manner, and which can be brought into contact with the engagement element upon activation and, as a result, provides an interlocking effect, which blocks a return rotation of the engagement element and, consequently, locks the device in the predefinable state.

The rotation of the engagement element into the position in which the engagement element can be brought into engagement with the receiving device, may be carried out independently of a relative movement of the two parts of the device towards one another. The engagement element may be rotatable, and in particular, pivotable, which is to say, it can be rotated back and forth with respect to at least one additional part of the engagement device, for example with respect to a bearing part of the engagement device. The apparatus can thus be particularly advantageously used in sliding doors. For example, the engagement device may be disposed on a fixed frame of a sliding door, in particular in a profile rail of the frame for the sliding door. The receiving device may be disposed on a movable part of the device, in particular in a profile rail of a frame of the sliding door.

The pivotable engagement element ensures that locking is ensured both in a space-saving manner, and such that said locking be reliably actuated. By blocking a return rotation of the engagement element by means of an interlocking effect, for example in that the locking element obstructs the engagement element, preventing a return rotation of said element, high locking forces can be implemented, for example high closing forces for keeping the safety device of a machine in a closed state.

In one embodiment of the invention, the engagement element has an engaging leg which, when the engagement element is in the starting position, and when the two parts of the device approach one another, can be inserted into a groove of the receiving device, said groove having an undercut.

The starting position of the engagement element can be releasably fixed, for example by means of a spring element, a latching element, or by means of a corresponding position of the locking element.

When the engagement element rotates, the engaging leg can engage in the undercut of the groove and as a result, locks the device in the predefinable state. Both the groove, and the surfaces of the engagement element, which are located together when the engagement element engages in the undercut of the groove, may be designed in such a way that a force that cancels the predefinable state of the device, for example a tractive force that opens the safety device of the machine from a closed state, automatically exerts a return force on the engagement element, for example a force that rotates the engaging leg back in the direction of the starting position thereof.

In one embodiment, the engagement element has a preferably concave locking surface, with which the locking element can be brought into contact when in an activated state. The locking surface may be located essentially opposite the engaging leg with respect to the first axis, about which the engagement element may be rotated. The locking element can be screwed in, in a space-saving manner, as a result of the concave shape. The locking surface may be at least partially circular. As a result of contact with the locking element, a return rotation of the engagement element is blocked by means of an interlocking effect, i.e., the locking does not require a frictional connection. As a result, the engagement element can be reliably blocked, even in the event that the effective lever arm of the locking surface is less than the effective lever arm of the engaging leg.

In one embodiment, when activated, the locking element can be rotated about a second axis, out of a starting position, and in so doing, can be brought into contact with the engagement element. Alternatively or additionally,

the locking element may also be slid into contact with the engagement element; the axis of rotation may correspond to the sliding direction or even the sliding axis. The locking element may be motor-driven. The locking surface of the engagement element and the surface of the locking element allocated thereto may also be designed in such a way that, when the locking element is activated, in particular when the locking element is rotated, the engagement element can be moved to a position, in which said engagement element is rotated completely out of the starting position thereof and as a result, can reliably be brought into engagement with the receiving device. The locking surface of the engagement element and contact surface of the locking element allocated thereto may be designed such that these are congruent, at least in sections.

In one embodiment, the first axis, about which the engagement element can be rotated, and the second axis, about which the locking element can be rotated, are oriented parallel to one another. As a result, the engagement device, and in particular, the first and second axes, can be more easily disposed in a groove of a profile rail in a space-saving manner. In particular, the locking element may be disposed below the engagement element in the groove such that said locking element is protected against mechanical damage.

In one embodiment, the engagement element has a first contact surface which, when the engagement device approaches the receiving device, can be brought into contact with a spreading means of the receiving device. As the engagement device further approaches the receiving device, the engagement element slides along the spreading means. In so doing, the engagement element can be rotated about the first axis. The first contact surface may be disposed at or near the free end on the engaging leg. For example, the first contact surface may be formed by an end section of the engaging leg,

which protrudes in a curved or oblique manner.

The spreading means of the receiving device may be fixed and, for example, may have an acute-angled guide bevel for the contact surface of the engaging leg.

In one embodiment, the engagement element has a second contact surface which, when the engagement device is removed from the receiving device, is brought into contact with a return means of the receiving device. As the engagement device is further removed from the receiving device, the second contact surface can slide along the return means and in so doing, the engagement element rotates back about the first axis in the direction of the starting position thereof. The second contact surface may be formed by a surface, which extends in a curved manner in sections, and in particular, in a concave, and/or oblique manner at or near the free end of the engaging leg. The return means of the receiving device may be formed by an edge of a profile, for example the edge of a groove of the profile, on or in which the receiving device is disposed, or which forms the receiving device.

In one embodiment, the engagement device is disposed having the engagement element and the locking element in a groove of a first profile rail, which groove has an undercut. The first profile rail can be secured to the first, preferably fixed part of the device, or may be an integral component of the first part of the device. For example, the first profile rail may be part of a frame of the first part of the device.

In one embodiment, the receiving device has a second profile rail, which can be secured on the second, preferably movable part of the device, or is an integral component of the second part of the

device. The groove of the receiving device, with which the engagement element can be brought into engagement, may be formed by the second profile rail. The second profile rail may be part of a frame of the second part of the device. The cross section of the profile rail may be identical to the cross section of the first profile rail, and in particular, the cross sections may be symmetrical to a center axis or two mutually perpendicular center planes.

In one embodiment, the engagement device has two, or a plurality of, engagement elements, each of which can be pivoted in the opposing directions to one another from the respective starting position thereof, and in so doing, can each be brought into engagement with the receiving device. The engagement elements can be pivoted at least in pairs, preferably about the same first axis and the engagement elements can be locked in the rotated state, at least in pairs, by the same locking element.

The invention also relates to a safety switch for signaling a predefinable state of a device, in particular the closed state of a safety device of a machine or the like, having an apparatus as described above. The safety switch has a read head, which can be secured to the one part of the device, preferably the part of the device having the engagement device, and has an actuator, which can be brought into an operative connection with the read head, preferably in a contactless manner. The actuator can be secured to the other part of the device, in particular to the movable second part of the device, located opposite the first part.

Further advantages, features and details of the invention will become apparent from the dependent Claims and the following description, in which

a plurality of exemplary embodiments are described in detail with reference to the drawings. In so doing, the features mentioned in the Claims and in the description may each be essential to the invention, either in and of themselves or in combinations thereof.

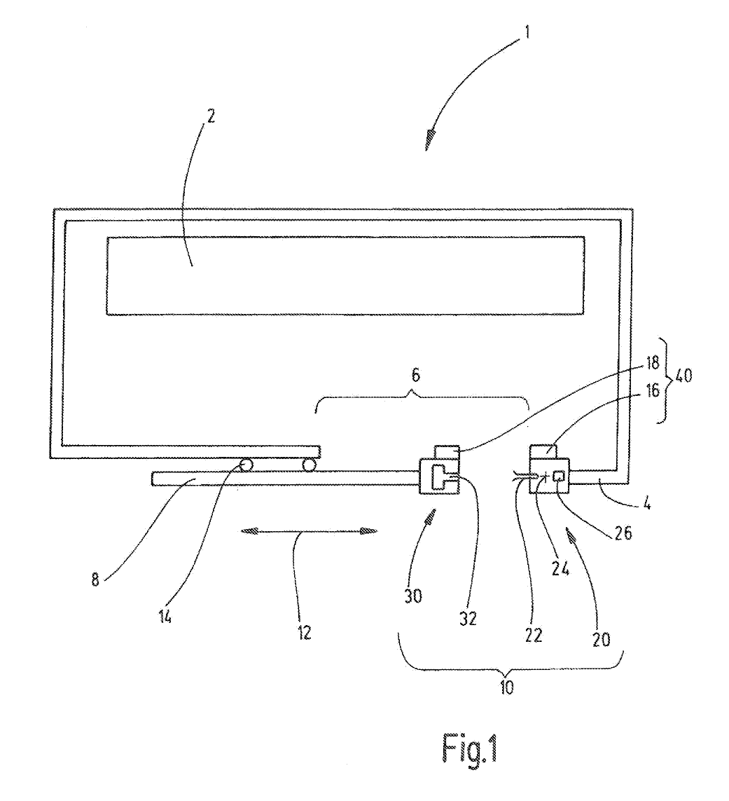

FIG. 1 shows a schematic depiction of a top view of a general arrangement of a safety device of a machine having an apparatus according to the invention,

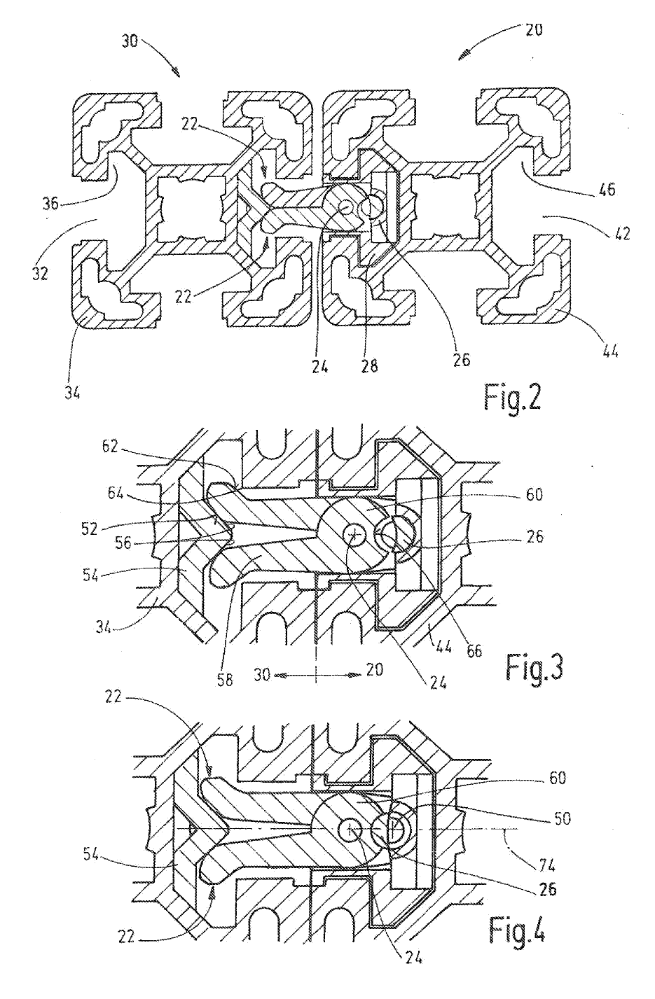

FIG. 2 shows an enlarged view of a section through the engagement device and the receiving device of the apparatus from FIG. 1,

FIG. 3 shows a further enlarged section of an apparatus, in which the device is in a completely closed state,

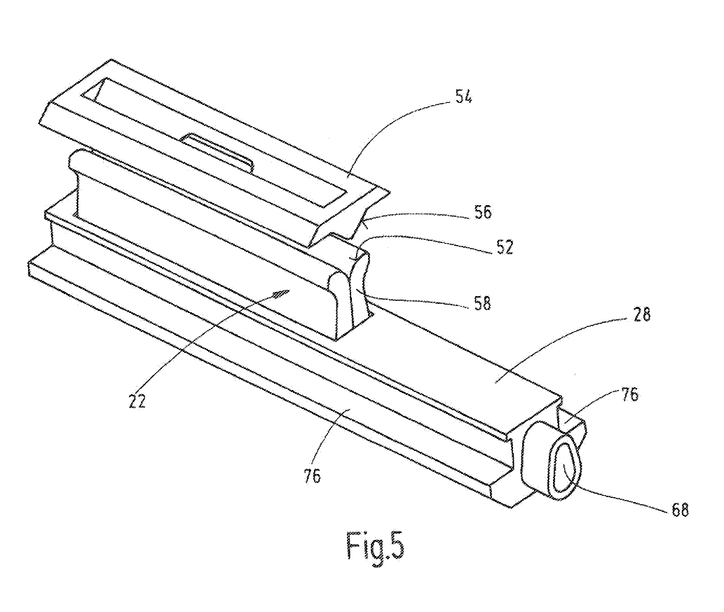

FIG. 4 shows the section of FIG. 3 having an activated locking element,

FIG. 5 shows a perspective view of the anchoring element, which is to be disposed in the groove of the first profile rail, and

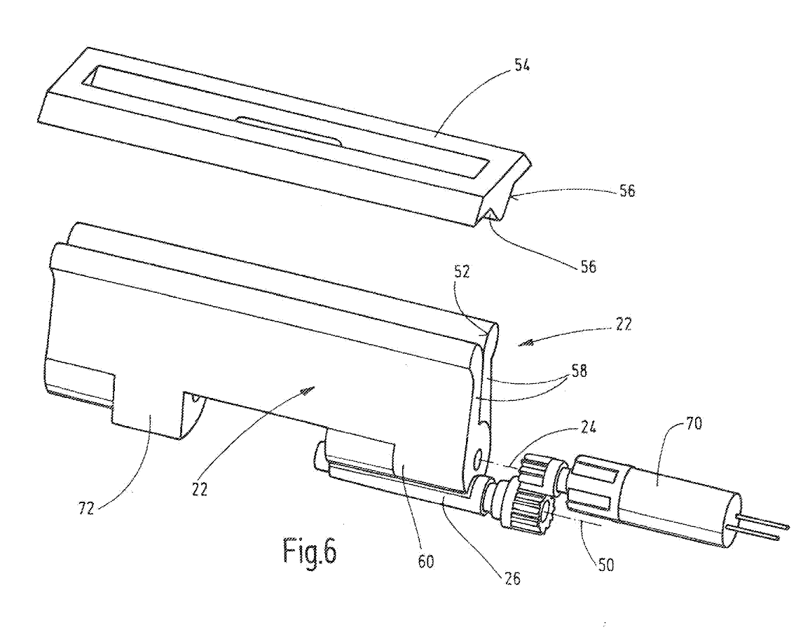

FIG. 6 shows a perspective view of the drive motor of the locking element.

FIG. 1 shows a schematic depiction of a top view of a general arrangement of a device 1, in which the safety device, for example a protective cage, of a machine 2 is depicted, having an exemplary embodiment of the apparatus 10 according to the invention for releasably locking the device 1 in the closed state. The device 1 has a first part 4, for example a frame of the device 1. The first part 4 has an opening 6, which can be closed by a second part 8, which in the case of the exemplary embodiment, is a sliding door, which is movably mounted by means of mounting elements 14, and

which can be moved in a manner corresponding to the double arrow 12 with respect to the first part 4.

The apparatus 10 has engagement device 20, which is secured to the first part 4 of the device 1, and which has two engagement elements 22 in this exemplary embodiment, such that in the embodiment, when the device 1 is in the closed state, in which it is to be locked, said engagement elements can be brought into engagement with a receiving device 30. The receiving device 30 is secured to the second part 8 of the device 1 or may also be an integral component of the second part 8 of the device 1.

The receiving device 30 has a groove 32 into which, when the engagement device 20 is in a starting position, the engagement elements 22 can be inserted, when the second part 8 is closed. When the device 1 is in the closed state, in which it is to be locked, the engagement elements 22 can be brought into engagement with the receiving device 30 and in particular, can be brought into engagement with a undercut 36 (FIG. 2) of the groove 32 by subsequently rotating the engagement elements 22 from the starting position depicted in FIG. 1 about a first axis 24, which extends perpendicular to the direction of movement 12 of the second part 8.

The apparatus 10 has a locking element 26, which can be activated in a controlled manner, and which can be brought into contact with at least one of the engagement elements 22 upon activation, and as a result, provides an interlocking effect, which blocks a return rotation of the engagement element 22, and thus locks the device 1 in the closed state.

In the exemplary embodiment, the apparatus 10 is an integral component of a safety switch 40, which also has a read head 16, which can be secured to the first part 4 of the device 1 and an actuator 18, which can be brought into

operative connection with the read head 16, preferably in a contactless manner, and which is secured to the second part 8 of the apparatus. In so doing, the read head 16 and the actuator 18 are disposed and adjusted in such a way that they are only in operative connection with one another when the device 1 is in a closed state.

FIG. 2 shows an enlarged view of a section through the engagement device 20 and the receiving device 30 in which the device 1 is in the nearly completely closed state. The engagement device 20 is disposed having the two engagement elements 22, which can be rotated about a first axis 24, and the motor-driven locking element 26 in an anchoring element 28, which is disposed in a groove 42 or a first profile rail 44, which groove has an undercut 46. The anchoring element 28 engages in the undercut 46 and as a result, is secured in the grove 42 by means of an interlocking effect, as a result of which, high locking forces can be achieved. The anchoring element 28 may have an outer contour, which essentially corresponds to that of the groove 42 and in particular, may be cylindrical. The first profile rail 44 may be secured to the first, fixed part 4 of the device 1 or, as in the exemplary embodiment, may even be an integral component of the first part 4 of the device 1. In deviating from the depiction in FIG. 1, the read head 16 may also be disposed partially or even completely in a groove 42 of the profile rail 44, in particular, in the same groove 42 as the anchoring element 28.

In the initial state of the two engagement elements 22 depicted in FIG. 2, which may be a self-adjusting initial state due to the gravitational force acting on the engagement elements 22, for example, or which may be an initial state that can be releasably fixed by means of a spring element, a catch means or the like,

the two engagement elements 22 can be inserted into a groove 32 of a second profile bar 34 when the device 1 is closed, which groove has an undercut 36. The second profile rail 34 can be secured to the second part 8 of the device 1 or may be an integral component of the second part 8 of the device 1. In particular, the cross section of the second profile rail 34 may be identical to that of the first profile rail 44.

FIG. 3 shows a further enlarged section of the apparatus 10, in which the device 1 is in a completely closed state. The second profile rail 34 is thereby substantially in contact with the first profile rail 44. The two engagement elements 22 are rotated about the first axis 24 in opposite directions from one another, starting from the starting position thereof depicted in FIG. 2. This occurs automatically as a result of the fact that, when closing and when the engagement device 20 approaches receiving device 30 in conjunction with said closing, a first contact surface 52 of the engagement element 22 is brought into contact with a spreading means 54 of the receiving device 30, and as the engagement device further approaches the receiving device, said contact surface slides along the spreading means 54, and as a result, the engagement element 22 rotates about the first axis 24.

To this end, the spreading means 54 has a spreading flank 56 for each engagement element 22. The two spreading flanks 56 may be flat, at least in sections, and the flat sections may form an angle of between 30° and 150°, in particular between 60° and 120°, and in the exemplary embodiment, preferably approximately 90°. The spreading means 54 is disposed in the groove 32, in particular at a bottom area of the groove 32. The first contact surface 52 of the engagement element 22 has a circular contour in sections. The first contact surface 52 is formed near a free end of the engaging leg 58 of the engagement element 22.

The engaging leg 58 is integrally formed with a bearing bushing 60, which encloses the first axis 24.

In the state depicted in FIG. 3, the engagement element 22 is already engaged with the undercut 36 of the groove 32 of the receiving device 30, however the engaging device is not yet locked in this rotated position, so that the device 1 is not yet locked in a closed state. The engagement element 22 has a second contact surface 62 which, when the engagement device 20 is removed from the receiving device 30, can be brought into contact with a return means 64 of the receiving device 30 and in so doing, the engagement element 22 rotates back about the first axis 24 in the direction of the starting position thereof, as depicted in FIG. 2.

In the exemplary embodiment, the return means 64 is formed by an edge of the second profile rail 34, which is formed at the transition to the undercut 36. The second contact surface 62 of the engagement element 22 may be planar, at least in sections. Embodiments are also possible in which the engagement element 22 has a return edge, which slides along a contact surface of the receiving device 30.

On the side opposite the engaging legs 58 in relation to the first axis 24, the bearing bushing 60 of the engagement element 22 has a concave locking surface 66, which extends, in particular, over an angle section of more than 60°, in particular, more than 90° and, in the exemplary embodiment, approximately 150°. In the state depicted in FIG. 3, the locking element 26 has not yet been activated. As a result, it is possible to pivot the engagement elements 22 about the first axis 24, at least to such a degree that it is possible to open the device 1.

FIG. 4 shows the section of FIG. 3 having an activated locking element 26. To this end, in the embodiment, the locking element 26 has been rotated approximately 180° about a second axis 50 and, as a result, has been brought into contact with the engagement element 22, in particular with the locking surface 66.

To this end, the cross section of the locking element 26 has a contour that is circular, at least in sections, which contour may be congruent with the contour of the locking surface 66, at least in sections. In the exemplary embodiment, the partially circular section extends over an angle range of more than 180°, in particular approximately 210°. The locking element 26 comes into contact with the engagement element 22 thereby, and blocks a return rotation of the engagement element 22.

The first axis 24 and the second axis 50 extend parallel to one another in the center plane 74 of the groove 42 and perpendicular to the plane of projection of FIGS. 2 through 4. FIGS. 2 through 4 show neither the read head 16, nor the actuator 18 of the safety switch 40 of FIG. 1, merely for reasons of simplifying the depiction. It is especially advantageous when the read head 16, which requires an electrical power supply, is disposed in that part of the device 1, which has the motor-driven locking element 26. In this case, no electrical power supply is needed for the other parts of the device 1.

Alternatively to the exemplary embodiment depicted, the engagement element 22 may also be implemented by means a motor-driven lifting of the spreading means 54 disposed at the bottom of the groove 32, so that, in this case, an electrical power supply is only needed for the part of the device 1 having the receiving device 30.

FIG. 5 shows a perspective view of the anchoring element 28, which is to be disposed in the groove 42 of the first profile rail 44 such that the two engagement elements 22 are in the non-rotated starting position starting position thereof, and having an electrical connection unit 68 for the drive motor 70 depicted in FIG. 6, and also shows the spreading means 54, which is to be disposed in the groove 32 of the second profile rail 34. The anchoring element 28 receives the drive motor 70 and the engagement elements 22 centrally, along the longitudinal axis of said anchoring element. The cross section of the anchoring element 28 is adapted to the groove 42 of the first profile rail 44. The two shoulders 76 of the anchoring element 28, which extend along the longitudinal axis, and which are located opposite one another with respect to the longitudinal axis, engage in the undercut 46 of the groove 42 in an interlocking manner.

FIG. 6 shows a perspective view of the drive motor 70, which drives the locking element 26 via a preferably translational gear train. Each of the two engagement elements 22 has an engaging leg 58, which extends axially over a length of more than 10 mm and in the exemplary embodiment, approximately 30 mm, said engaging leg having an integrally formed bearing bushing 60 at or, respectively, near the axial end thereof for the first axis 24. Each engagement element 22 has an additional bearing point 72 at or, respectively, near the opposite axial end thereof, by means of which bearing point, the engagement element 22 is pivotably mounted in the anchoring element 28. It is especially advantageous that both the bearing point of the engagement elements 22 and the drive motor 70 are protected in the anchoring element 28, and in turn, are disposed with said anchoring element in the groove 42 of the first profile rail 44.

1. An apparatus (10) for releasably locking a device (1) in a predefinable state, in particular for releasably keeping a safety device of a machine (2) in a closed state, said apparatus having an engagement device (20), which can be secured on a first part (4) of the device (1), said apparatus having at least one engagement element (22), which can be brought into engagement with a receiving device (30) when the device (1) is in the predefinable state, in which said device is to be locked, which receiving device can be secured on a second part (8) of the device (1), or is an integral component of the second part (8) of the device (1), and as a result of which, the device (1) can be locked in the predefinable state, characterized in that the engagement element (22) can be rotated about a first axis (24) out of a starting position, and in so doing, can be brought into engagement with the receiving device (30) when the device (1) is in the predefinable state, in which said device is to be locked, and in that the apparatus (10) has an locking element (26), which can be activated in a controlled manner, and which can be brought into contact with the engagement element (22) upon activation and as a result, provides an interlocking effect, blocks a return rotation of the engagement element (22), and consequently locks the device (1) in the predefinable state.

2. The apparatus (1) according to claim 1, characterized in that the engagement element (22) has an engaging leg (58) which, when the engagement element (22) is in the starting position and when the two parts (4, 8) of the device (1) approach one another, can be inserted into a groove (32) of the receiving device (30), which groove has an undercut (36), and in that, when the engagement element rotates, the engaging leg (58) (22) engages in the undercut (36) of the groove (32) and, as a result, locks the device (1) in the predefinable state of the device.

3. The apparatus (1) according to claim 1, characterized in that the engagement element (22) has a preferably concave locking surface (66), with which the locking element (26) may be brought into contact when in an activated state and, as a result, said engagement provides an interlocking effect, blocks a return rotation of the engagement element (22).

4. The apparatus (1) according to claim 1, characterized in that, when activated, the locking element (26) can be rotated about a second axis (50) and/or moved out of a starting position, and in so doing, can be brought into contact with the engagement element (22) and as a result, provides an interlocking effect, which blocks a return rotation of the engagement element (22).

5. The apparatus (1) according to claim 4, characterized in that the first axis (24), about which the engagement element (22) can be pivoted, and the second axis (50), about which the locking element (26) can be rotated, extend parallel to one another.

6. The apparatus (1) according to claim 1, characterized in that the engagement element (22) has a first contact surface (52) which, when the engagement device (20) approaches the receiving device (30), can be brought into contact with a spreading means (54) of the receiving device (30) and, as the engagement device further approaches the receiving device, said contact surface slides along the spreading means (54) and as a result, the engagement element (22) rotates about the first axis (24).

7. The apparatus (1) according to claim 1, characterized in that the engagement element (22) has a second contact surface (62) which, when the engagement device (20) is removed from the receiving device (30), can be brought into contact with a return means (64) of the receiving device (30), and as the engagement device is further removed from the receiving device, said contact surface slides along the return means (64) and in so doing, the engagement element (22) is rotated back about the first axis (24) in the direction of the starting position thereof.

8. The apparatus (1) according to claim 1, characterized in that the engagement device (20), having the engagement element (22) and the locking element (26), is disposed in a groove (42) of a first profile rail (44), which groove has an undercut (46), which engagement device may be secured on the first, preferably fixed part (4) of the device (1) or is an integral component of the first part (4) of the device (1).

9. The apparatus (1) according to claim 1, characterized in that the receiving device (30) has a second profile rail (34), which can be secured on the second, preferably movable part (8) of the device (1), or is an integral component of the second part (8) of the device (1), and in that the groove (32) of the receiving device (30) is formed by the second profile rail (34).

10. The apparatus (1) according to claim 1, characterized in that the engagement device (20) has two engagement elements (22), each of which can be rotated in opposing directions to one another out of the respective starting position thereof and in so doing, can each be brought into engagement with the receiving device (30).

11. A safety switch (40) for signaling a predefinable state of the device (1), in particular the closed state of a safety device of a machine (2) or the like, characterized in that the safety switch (40) has an apparatus (10) according to claim 1, and in that the safety switch (40) has a read head (16), which can be secured on the one part (4, 8) of the device (1), and has an actuator (18), which can be brought into an operative connection with the read head (16), preferably in a contactless manner, and which can be secured to the other part (8, 4) of the device (1).
